(19) United States
(12) Patent Application Publication
(10) Pub. No.: US 2012/0290439 A1
(43) Pub. Date: Nov. 15, 2012

(54) DIGITAL DIRECTORY OF BRAND GOODS USED IN MOTION PICTURES AND MEDIA

(76) Inventor: ERIKA SMITH, Beverly Hills, CA (US)

(21) Appl. No.: 13/438,156

(22) Filed: Apr. 3, 2012

Related U.S. Application Data
(60) Provisional application No. 61/484,887, filed on May 11, 2011.

(51) Int. Cl. G06Q 30/06

(52) U.S. Cl. 705/26.62; 705/26.61; 705/27.1

(57) ABSTRACT

A method for online marketing may include the steps of collecting procurement data relating to items that are portrayed in entertainment media productions or in public images of a celebrity and electronically correlating the procurement data into a processor searchable data base. The correlated procurement data may be presented on a processor searchable website that is accessible to consumers. An operator of the website may accept online procurement orders from the consumers for any of the items.

### RELATED APPLICATIONS

This application claims the benefit of U.S. Provisional Patent Application No. 61/484,887 filed on May 11, 2011.

### BACKGROUND OF THE INVENTION

The present invention generally relates to online marketing of goods that consumers may associate with use by celebrities. For example, a celebrity may wear a particular article of clothing in an entertainment production or a public appearance. A consumer who sees the entertainment production or public appearance may be provided with an opportunity to identify and purchase the same or a similar article of clothing.

Producers of entertainment media productions such as motion pictures, television shows or music videos may employ clothing and set furnishings that are purchased or borrowed from vendors of such items. For example, an actress may appear in a music video wearing a dress that is provided to a producer by a clothing manufacturer or retailer. The same actress may also be shown sitting or standing next to an article of furniture such as a chair or table that may also be provided by a manufacturer or retailer of the furniture item. These items typically do not display product identification such as logos. Indeed many producers would not want to present overt product identification in their productions out of concern that the production may take on the appearance of an “infomercial”.

Nevertheless, there is a potential for mutual economic advantage for celebrities and media producers to participate in the revenue stream derived from consumer purchases of the aforementioned items. Further, celebrities, media producers and vendors of goods, based on data collected from consumer purchases, may ultimately engage in product placement of various unlabeled goods in entertainment media productions and various public images. If a viewer sees a particular article of clothing or furniture that he or she may want for his or her own use, that viewer may begin shopping to find such an item for purchase.

As can be seen, there is a need for a system in which a viewer may readily learn a source for an item and then acquire the particular item that may strike his or her fancy during viewing, in spite of the item not being overtly identified in the viewed production or image. There is also a need for celebrities and production entities to enable the operator of the system to inventory items appearing in production media and to use production media for commercial use.

### SUMMARY OF THE INVENTION

In one aspect of the present invention, a method for online marketing may comprise the steps of: collecting procurement data relating to items that are portrayed in entertainment media productions or celebrity public appearances; electronically correlating the procurement data with titles of particular productions and names of celebrities; presenting the correlated procurement data on a website that is accessible to consumers as processor searchable content; and accepting online procurement orders from the consumers for any of the items.

In another aspect of the present invention, a website for marketing items portrayed in entertainment media productions and celebrity public images may comprise: machine-based code formulated to display images of items as processor searchable content relating to titles of entertainment media productions or names of celebrities; and machine-based code formulated to present purchase option prompts to a consumer upon selection of an image of an item to be purchased.

These and other features, aspects and advantages of the present invention will become better understood with reference to the following drawings, description and claims.

### BRIEF DESCRIPTION OF THE DRAWINGS

FIG. 1 is a flow chart of a system for marketing in accordance with an embodiment of the invention;

FIG. 2 is a block diagram of the system of FIG. 1 in accordance with an embodiment of the invention;

FIG. 3 is a block diagram of an exemplary screen view of a website in accordance with an embodiment of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide systems for electronically compiling a processor searchable inventory list of potentially purchasable items that appear in entertainment productions or public appearances of celebrities and providing a viewer with purchasing access to items on the inventory list.

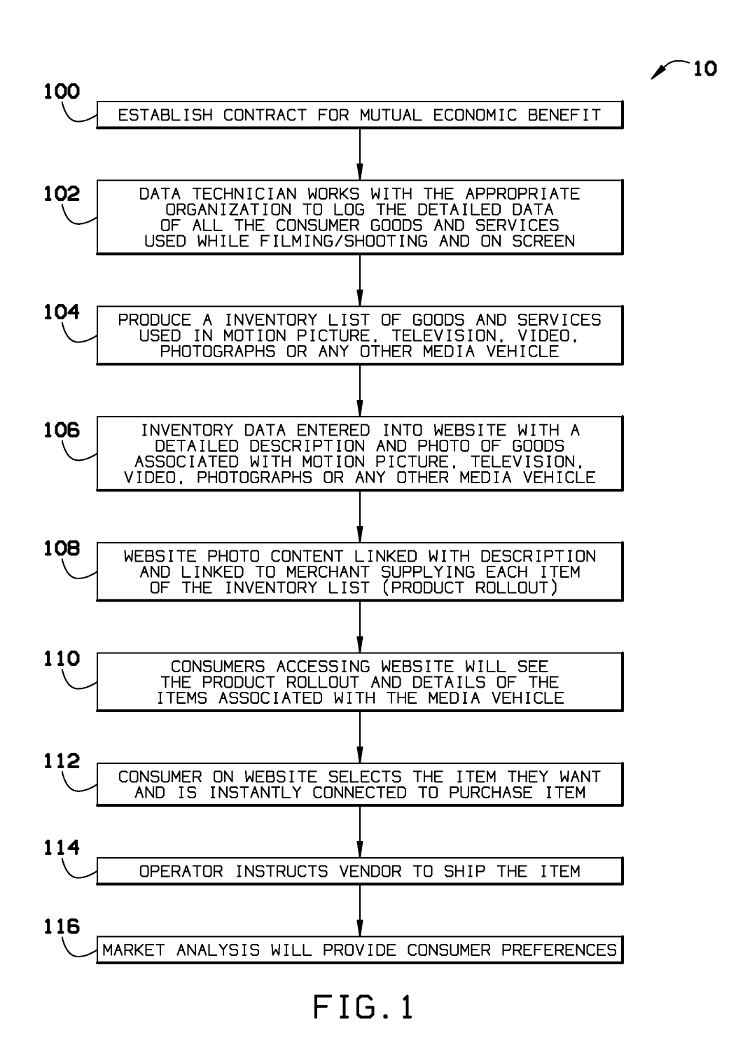

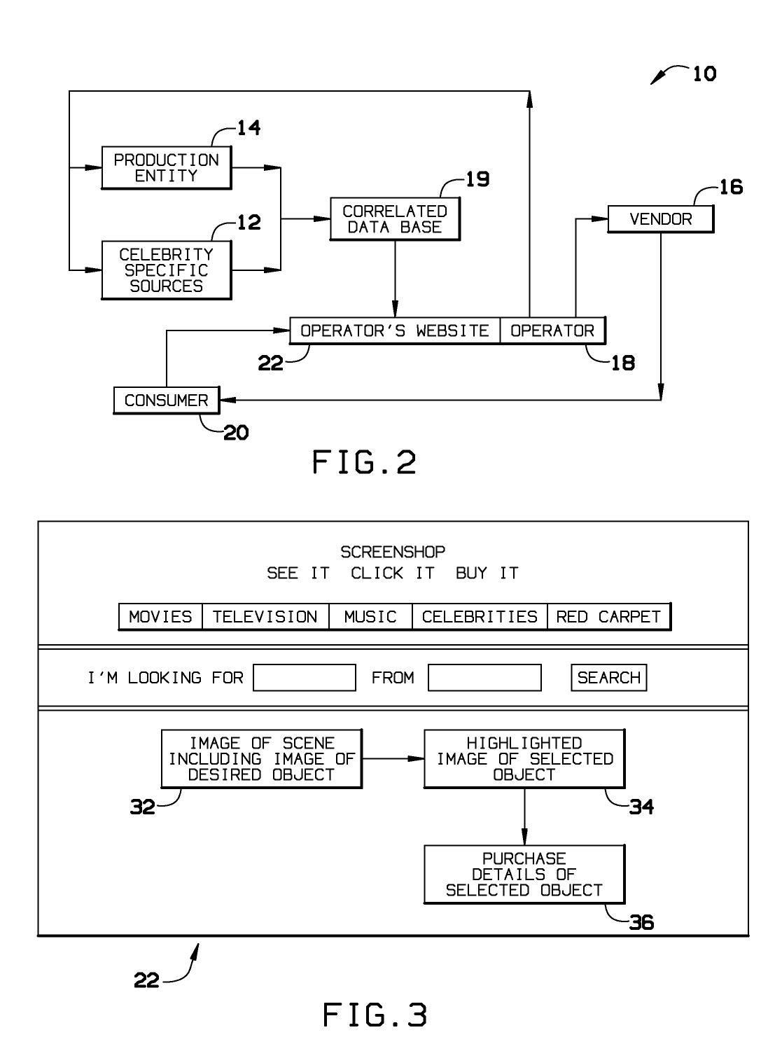

Referring now to the Figures, it may be seen that a system 10 for marketing goods shown in entertainment media or celebrity public appearances may include steps shown in a flow chart of FIG. 1, may comprise a structure as shown in FIG. 2 and may utilize a website such as that illustrated in FIG. 3.

In a step 100, a contract may be established between a celebrity 12 or an entertainment production entity 14 and an operator 18 of the system 10. The operator 18 may agree to place the items onto a processor searchable electronic inventory list and maintain the list and a sales channel for the item on a website 22 that is maintained by the operator 18. The celebrity 12 and/or the production entity 14 may agree to allow access to employees of the operator 18 so that the inventory list can be compiled by the operator 18 and formulated into a correlated data base 19. The celebrity 12 and/or production entity 14 may also grant a license (e.g. a limited copyright license) to the operator 18 that permits the operator 18 to display relevant portions of the production on the operator's website 22.

As to each one of the production entities 14 or celebrities 12, the operator may perform a step 102 which may include sending operator staff members to a production site to communicate with production staff members and develop a list of all relevant consumer products or services that may be portrayed in the production or by the celebrity.

Alternatively, operator staff members may interview or otherwise communicate with a celebrity directly to learn the identity of items that may appear in public appearance photos or videos of the celebrity. In some instances a celebrity may maintain a website and items that appear in such a website may be inventoried and then offered for sale as a unique “Celebrity-specific Boutique”.

In steps 104 and 106, the operator 18 may formulate inventory data for multiple productions while developing correlation data that identifies each item with one or more productions in which the item is to be portrayed. The correlated data may be entered into a data base 19 that may be accessible to a potential consumer 20 on the website 22 that may be maintained and operated by the operator 18. The correlated data base 19 may include, among other things, graphical images of the items 34, actors who appeared with the items and scenes in which the items appeared 32.

The agreement between the operator 18 and the celebrity 12 or production entity 14 may include various economic incentives. For example, the operator 18 may agree to share the fees it earns from vendors 16 for sale of products. A percentage may go to the production entity 14 for sales associated with productions. A percentage may go to the celebrity 12 for sales associated with the celebrity's image and likeness. Such agreements may be particularly useful to incentivize copyright clearance for use of content and, in the case of the celebrity, commercial use of image and likeness.

Operator 18 may enter into agreements with vendors of the goods and, in exchange, may receive fees based on a percentage of the total sale. These fees are what the operator may share with the production entity or the celebrity as applicable.

In a step 108, the operator 18 may gather procurement information or data from the vendor 16 for each of the items. The procurement data may include, among other things, brand identity, price of item, size availability and color availability.

In steps 110 and 112, the prospective consumer 20 may access the website 22 of the operator 18 and find an item which caught his or her fancy while viewing a production or celebrity image. For example, a female viewer may have seen her favorite actress wearing a particularly attractive pair of shoes in a movie. That viewer may enter the website 22 and follow a series of prompts in which she may enter the name of the movie, the name of the actress and identify a category of interest such as shoes. She may then be provided with a series of brief graphical clips 32 that would show all scenes of the actress of interest in the movie of interest in which any shoes are portrayed. Alternatively, the prospective consumer 20 may decide to view all of the shoes that her favorite actress has worn in any public appearance or in any production irrespective of the title of the production. The correlated data may allow for such a selection process.

When the particular shoes of interest appear on a screen of the consumer's internet viewing device, she may then mouse-over or click on the image of the shoes of interest. The screen may then highlight the shoes, in a highlighted image 34 and display procurement data 36 for the shoes or similar items (e.g., brand identity, price, size availability and/or color availability). Additionally, the screen may display a purchase-now option that may be selected by the consumer.

Selection of the purchase-now option may lead the consumer to a series of prompts that may allow the consumer to place an order and make payment arrangements for the shoes of interest. In other words, the consumer sees the item, clicks on it and then buys it.

In a step 114, the operator 18 may notify the vendor 16 to ship the selected item to the consumer 20. After confirmation that the consumer 20 has not returned the item for a refund (e.g., after 60 days), the operator 18 may send an agreed upon percentage of the purchase price of the item to the production entity 14 or celebrity 12. The operator 18 may make payment to the vendor 16 either at the time that a purchase is initiated or at a later time after determination that the consumer does not seek a refund from the operator 18.

In an optional step 116, the operator may perform market analysis studies by analyzing sales data and provide consumer preference reports to one of more of the production entities 14, celebrities 14 and/or vendors 16.

It should be understood, of course, that the foregoing relates to exemplary embodiments of the invention and that modifications may be made without departing from the spirit and scope of the invention as set forth in the following claims.

What is claimed is:

1. A method for online marketing comprising the steps of:
collecting procurement data relating to items or services that are portrayed in entertainment media productions or celebrity public appearances;
electronically correlating the procurement data with titles of particular productions and names of celebrities;
presenting the correlated procurement data on a website that is accessible to consumers as processor searchable content; and
accepting online procurement orders from the consumers for any of the items or services.

2. The method of claim 1 wherein the items comprise product placement items supplied to production entities by vendors of the items.

3. The method of claim 1 wherein the step of presenting the correlated procurement data includes displaying a highlighted image of the item.

4. The method of claim 3 further comprising the step of presenting procurement data for the item to the consumer when the consumer selects an image of the item on the website.

5. The method of claim 4 wherein the procurement data includes price of the item.

6. The method of claim 4 wherein the procurement data includes size availability and color availability of the item.

7. The method of claim 4 wherein the procurement data includes a brand identity of the item.

8. The method of claim 4 wherein the procurement data includes references to similar items.

9. The method of claim 1 further comprising the step of providing the production entity or celebrity with a percentage of sales revenue derived from sale of items portrayed in the productions of the entity.

10. The method of claim 1 further comprising the step of performing market analysis studies by analyzing online sales the items and providing consumer preference reports to one of more of the vendors, production entities or celebrities.

11. A website for marketing items portrayed in entertainment media productions and celebrity public images comprising;
machine-based code formulated to display images of items as processor searchable content relating to titles of entertainment media productions or names of celebrities; and
machine-based code formulated to present purchase option prompts to a consumer upon selection of an image of an item to be purchased.

12. The website of claim 11 further comprising machine-based code formulated to display and allow selection of names of performers in a selected production.

13. The website of claim 11 further comprising machine-based code formulated to allow a prospective consumer to enter a performer's name and to select categories of items without identifying a particular title of an entertainment media production.

14. The website of claim 11 further comprising machine-based code formulated to display procurement data relating to an item upon selection of the item by a user of the website.

15. The website of claim 14 wherein the procurement data includes brand identity of the selected item.
